(19) United States
(12) Patent Application Publication
(10) Pub. No.: US 2025/0046041 A1
(43) Pub. Date: Feb. 6, 2025

(54) METHOD FOR PROCESSING ATTACHMENT/REMOVAL OF ITEM FOR TO-BE-DRESSED NFT MODEL, AND SYSTEM FOR SAME

(71) Applicant: CORK, INC., Tokyo (JP)

(72) Inventors: Hideyuki TAKEI, Tokyo (JP); Kosuke SHINDO, Tokyo (JP)

(21) Appl. No.: 18/720,459

(22) PCT Filed: Nov. 10, 2022
(86) PCT No.: PCT/JP2022/041833

§ 371 Date: Sep. 20, 2024

(30) Foreign Application Priority Data
Dec. 17, 2021 (JP) 2021-205447
Jan. 25, 2022 (JP) 2022-009407

(51) Int. Cl. G06T 19/20; G06Q 20/36; G06Q 20/38

(52) U.S. Cl. CPC G06T 19/20; G06Q 20/367; G06Q 20/389; G06T 2200/24; G06T 2219/2008

(57) ABSTRACT

Providing an NFTed avatar that may be used across different metaverses and may be dressed up with different items. There is provided a method for processing dress-up of an NFTed avatar by a computer, and the method comprises the steps of: referencing, by the computer, a smart contract for the avatar and data for displaying the avatar, and displaying the avatar to a user; referencing, by the computer, a smart contract for items and data for displaying the items, and displaying the items to a user; providing the user, by the computer, with a try-on interface for trying items on the avatar; providing the user, by the computer, with an interface for allowing the user to decide items to attach to the avatar; and executing, by the computer, based on the user's decision on items to be attached on the avatar, a writing on the blockchain for associating item NFTs with an avatar NFT for the smart contract for the avatar.

### FIELD OF THE INVENTION

The present invention relates to a method for processing attachment and removal of item for a to-be-dressed NFT model and a system thereof, and in particular, relates to a method for dressing up an NFTed avatar and a system thereof.

### BACKGROUND OF THE INVENTION

### Metaverse and Avatar

Currently, the “metaverse,” a three-dimensional virtual space on the Internet, is attracting attention.

There are various types of metaverses, including games, but in general, users can control their avatars (their alter egos) in the metaverse and enjoy playing games and living in another world, such as interacting with other users and defeating enemies online via the Internet. This allows users to feel as if they themselves are in a metaverse.

In such a metaverse, users may also upgrade their avatars by collecting various items for attaching them to their avatars and/or changing them. This is designed to enhance the experience in the metaverse.

### Blockchain and Avatar

Another reason why this metaverse is attracting attention is that, in combination with the blockchain technology, the digital data used within this metaverse may be capitalized with increased security and convenience.

In other words, the construction of a metaverse by leveraging a blockchain makes it possible to create assets in the metaverse. In other words, by using NFT technology, assets such as avatars and/or in-game items may be added with the information of their creators and/or owners, allowing the assets to have uniqueness in the metaverse.

Thus, NFTs capitalize digital content, including avatars in the metaverse, and make it available for distribution on the Internet. In fact, NFTs are already being bought and sold around the world, with the largest NFT marketplace, OpenSea®, having a total circulation of over 350 billion yen in August 2021.

In such NFT marketplaces, a person who wishes to trade displays the person's own digital content to either assign a price to the NFT for that content or sell it through an auction system.

### Prior Art Document

Patent Document

Non-Patent Document

### SUMMARY OF THE INVENTION

### Problem to be Solved by the Invention

Incidentally, in many metaverses including games, avatars may only be used in that particular metaverse and may not be used in another metaverse. Even in such cases, avatars may be NFTed, but they are still only usable in that metaverse.

Some of them may be used across a plurality of different metaverses, but items and/or costumes purchased in a particular metaverse are only valid within that particular metaverse, so items and/or costumes attached to avatars may not be distributed on the blockchain along with avatars, and must be managed separately from avatars.

Considering the above situation, the purpose of the present invention is to provide an NFTed avatar that may be used across different metaverses and may be dressed up with different items.

### Means for Solving the Problem

In order to overcome the above challenges, the following invention is provided according to a principal aspect of the present invention.

(1) A method for processing, by a computer, attachment and removal of item for a to-be-dressed NFT model, comprising the steps of:
storing, by the computer, data for displaying the model;
storing, by the computer, data for displaying items for attaching to the model;
providing, by the computer, a smart contract for the model on a blockchain;
providing, by the computer, a smart contract for the items on the blockchain;
referencing, by the computer, the smart contract for the model data and the data for displaying the model, and displaying the model to a user;
referencing, by the computer, the smart contract for the items and the data for displaying the items, and displaying the items to a user;
providing the user, by the computer, with a try-on and removal interface for trying items on and removing the items from the model;
providing the user, by the computer, with an interface for allowing the user to decide items to attach to the model; and
executing, by the computer, based on the user's decision on the item attachment to or detachment from the model, a transaction on the blockchain for associating or disassociating item NFTs for the attached or detached items with or from a model NFT for the smart contract for the model.

(2) The method of the above (1), wherein
the model is an avatar.

(3) The method of the above (1), further comprising the step of
updating the data for displaying the model after the item attachment or detachment based on the execution of the transaction for the smart contract for the model.

(4) The method of the above (1), further comprising the step of
providing a user interface for displaying the model after the item attachment or detachment based on the data for displaying the model after the dress-up.

(5) The method of the above (1), wherein
the step of executing the transaction executes both or either one of: a transaction for changing ownership addresses of the item NFTs of the items to be attached to the model from the user's wallet address to smart contract addresses of the item avatar NFT, and/or a transaction for changing ownership addresses of the item NFTs of the items to be detached from the model from the smart contract addresses of the item avatar NFT to the user's wallet address.

(6) The method of the above (5), wherein
when there are an item or items to be detached from the model and an item or items to be attached to the model,
after executing the transaction for changing ownership addresses of the item NFTs of the items to be detached from the model from the smart contract addresses of the item avatar NFT to the user's wallet address,
execution of the transaction for changing ownership addresses of the item NFTs of the items to be attached to the model from the user's wallet address to smart contract addresses of the item avatar NFT is permitted.

(7) The method of the above (5), wherein
the step of providing the user, by the computer, with an interface for allowing the user to decide items to attach to the model
displays a button or a link on the interface for allowing the user to execute the transaction for attaching or detaching items for each smart contract.

(8) The method of the above (7), wherein
the button or the link for allowing the user to execute the transaction for attaching items
is activated or displayed after the transaction for detaching items is executed.

(9) The method of the above (2), further comprising the step of
generating, by the computer, the data for displaying the model data for use in a specific metaverse, and allowing its download.

(10) A system for processing, by a computer, attachment and removal of item for a to-be-dressed NFT model,
wherein there are provided on a blockchain, a smart contract for the model and a smart contract for attached/detached items,
said system comprising:
a model display data storage section for storing, by the computer, data for displaying the model;
an item display data storage section for storing, by the computer, data for displaying items for attaching to the model;
a model display section for referencing, by the computer, the smart contract for the model and the data for displaying the model data, and displaying the model to a user;
an item display section for referencing, by the computer, the smart contract for the items and the data for displaying the items, and displaying the items to a user;
a try-on and removal interface providing section for providing the user, by the computer, with a try-on and removal interface for trying items on and removing the items from the model;
a decision interface providing section for providing the user, by the computer, with an interface for allowing the user to decide items to attach to the model; and
a smart contract communication processing section for executing, by the computer, based on the user's decision on the item attachment to or detachment from the model, a transaction on the blockchain for associating or disassociating item NFTs for the attached or detached items with or from a model NFT for the smart contract for the model.

It is to be noted that other characteristics and marked effects of the present invention will be appreciated to those skilled in the art upon referring to the following detailed description of the preferred embodiments and the accompanying drawings.

### BRIEF DESCRIPTION OF THE DRAWINGS

FIG. 1 is a schematic structural view of an avatar showing one embodiment of the present invention;

FIG. 2 is a schematic structural view showing items according to the one embodiment;

FIG. 3 is a schematic structural view showing a dress-up avatar according to the one embodiment;

FIG. 4 is a schematic configuration diagram showing an overall network configuration according to the one embodiment;

FIG. 5 is a schematic configuration diagram showing a smart contract of avatar NFTs according to the one embodiment;

FIG. 6 is a schematic configuration diagram showing a configuration of item NFTs and the avatar NFTs according to the one embodiment;

FIG. 7 is a schematic configuration diagram showing the dress-up avatar according to the one embodiment;

FIG. 8 is a schematic configuration diagram showing a smart contract of the item NFTs according to the one embodiment;

FIG. 9 is a flowchart for displaying an NFT in an NFT marketplace according to the one embodiment;

FIG. 10 is a schematic configuration diagram showing a dress-up app according to the one embodiment;

FIG. 11 is a flowchart showing association with a wallet according to the one embodiment;

FIG. 12 is a flowchart showing a dress-up process according to the one embodiment;.

FIG. 13 is a flowchart showing writings into the smart contract according to the one embodiment;

FIG. 14 is a schematic structural view showing an app interface according to one embodiment;

FIG. 15 is a schematic configuration diagram showing the smart contract according to the one embodiment;

FIG. 16 is a schematic configuration diagram showing the smart contract according to the one embodiment;

FIG. 17 is a schematic configuration diagram showing links of the avatar NFT and the item NFTs according to the one embodiment;

FIG. 18 is a schematic configuration diagram showing the smart contract according to the one embodiment;

FIG. 19 is a schematic configuration diagram showing the smart contract according to the one embodiment;

FIG. 20 is a schematic configuration diagram showing links of the avatar NFT and the item NFTs according to the one embodiment;

FIG. 21 is a schematic structural view showing an avatar data generation server according to one embodiment;

FIG. 22 is a schematic structural view showing an interface of the dress-up app according to the one embodiment;

FIG. 23 is a schematic structural view showing the interface of the dress-up app according to the one embodiment;

FIG. 24 is a schematic structural view showing the interface of the dress-up app according to the one embodiment;

FIG. 25 is a schematic structural view showing the interface of the dress-up app according to the one embodiment;

FIG. 26 is a schematic structural view showing the interface of the dress-up app according to the one embodiment;

FIG. 27 is a schematic structural view showing the interface of the dress-up app according to the one embodiment;

FIG. 28 is a schematic structural view showing the interface of the dress-up app according to the one embodiment; and

FIG. 29 is a flowchart showing a transaction for linking the avatar NFT and the item NFTs according to the one embodiment.

### DETAILED DESCRIPTION OF THE INVENTION

One embodiment of the present invention will be described in detail below with reference to accompanying drawings.

Before describing a structure of the one embodiment of the present invention, the concept of avatars and avatar NFTs that may be generated by this embodiment will be explained.

### 1. Avatar

An avatar, as described above, is a three-dimensional shape utilized in the metaverse space for representing oneself.

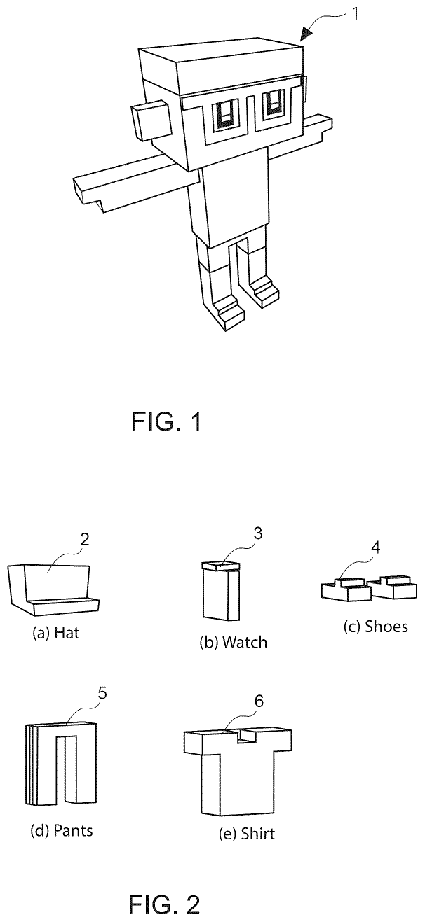

FIG. 1 shows the body base avatar 1.

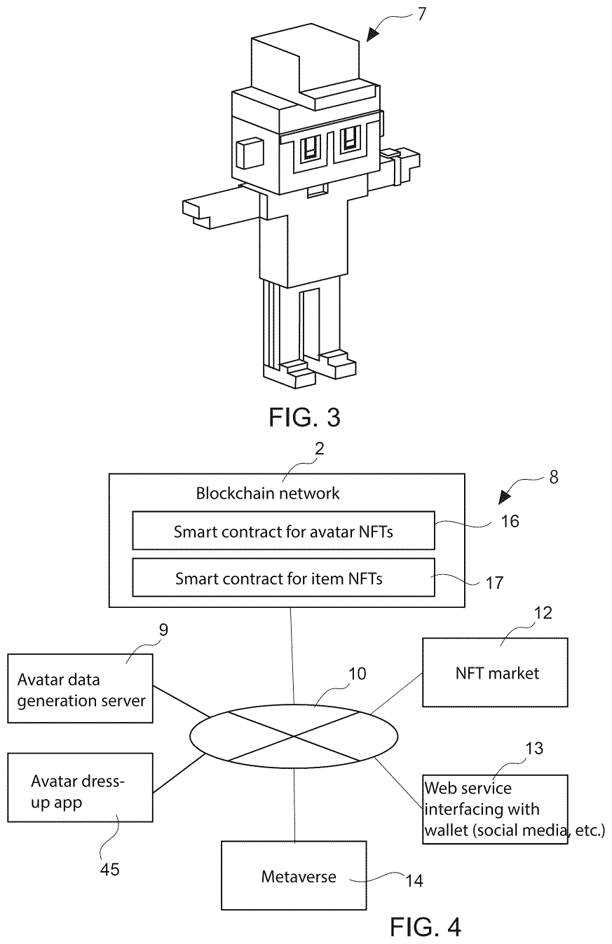

A body base avatar refers to a character that is generally naked and wears no items. In this embodiment, the avatar may be fitted with items such as a hat 2, a watch 3, shoes 4, pants 5, a shirt 6 and the like as shown in FIG. 2 to generate a dress-up avatar as shown in FIG. 3.

Thus, by generating the dress-up avatar 7, a user may create an avatar that looks like the user and display the user's preferences to others.

### 2. Avatar NFT

The above body base avatar 1 (FIG. 1) is NFTed by an avatar NFT generation smart contract, which will be described in detail below, and an avatar NFT token ID is associated with the owner address (wallet address) of that NFT and stored in the smart contract on a blockchain as a variable.

The 3-dimensional data of the above avatar may be referenced by the above avatar NFT token ID by the above avatar NFT generation smart contract, and by processing this 3-dimensional shape data, an body base avatar with the appearance, as shown in FIG. 3, is adapted so that it may be displayed and moved in the metaverse.

When the above dress-up avatar is generated by attaching items to this body base avatar, the 3-dimensional shape data referenced by the above avatar NFT ID is updated to display this dress-up avatar, and the avatar may be displayed and moved in the metaverse.

In addition, since this dress-up avatar is NFTed, it may be traded on the NFT marketplace with the items attached through this dress-up.

In this embodiment, the items attached by the above dress-up are also NFTed and may be respectively transferred to other individuals in the NFT marketplace and/or metaverse independently of the body base avatar before they are attached to the avatar, but after they are attached to the body base avatar, the NFTs of these items are associated with the body base avatar's ID as a parent and children, and may be transferred together with this avatar.

The one embodiment of the present invention provides a system for dressing up an NFTed avatar 1 as described above. The system will be discussed in detail below.

### 3. Overall Configuration

FIG. 4 shows an avatar data generation system 18, which is an embodiment of the present invention.

This system 8 has an avatar data generation server 9, and this avatar data generation server 9 is inter-communicably connected via the Internet 10 to a blockchain network 13, an NFT marketplace 12, and a web service 14 interfacing with a wallet.

### 4. Blockchain Network

The above blockchain network 11 is a network composed of a plurality of server/computer groups, installed with programs capable of executing smart contracts, such as Ethereum and an sidechain polygon. And on this blockchain, all the NFT data of avatars and items are adapted to be stored and managed.

### 5. Smart Contracts

To achieve avatar NFT-ization in the present invention, a smart contract 16 for avatar NFT generation and a smart contract 17 for item NFTs are installed on the blockchain network 11 (FIG. 4).

Here, a smart contract is a program that runs on a blockchain of Ethereum or the like, wherein the program is capable of internally maintaining variables such as integers, strings, arrays and the like, as well as defined functions to be called externally.

The smart contracts used in this embodiment are the smart contract 16 for avatar NFTs and the smart contract 17 for items to be attached to the avatar. They will be described below.

### 6. Smart Contract for Avatar NFTs

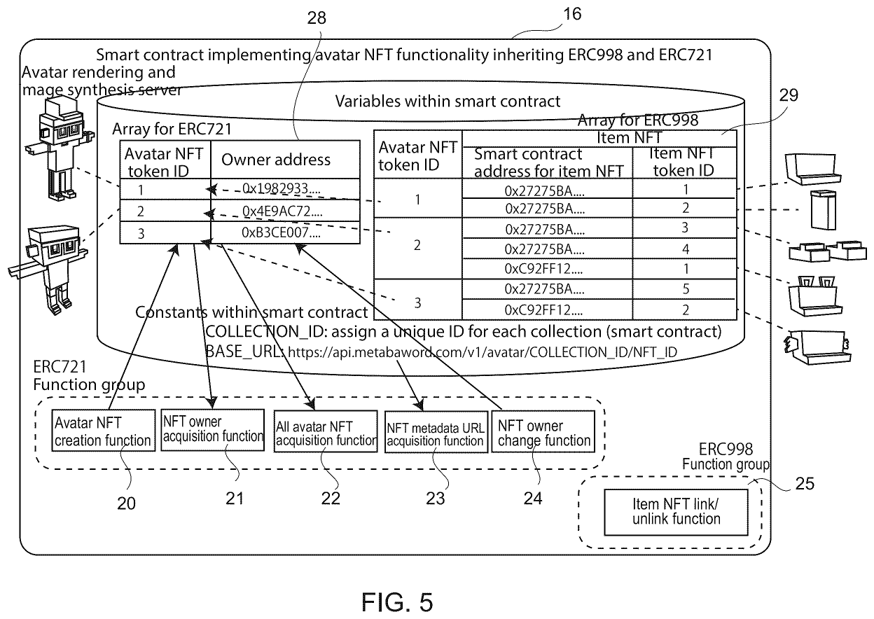

As shown in FIG. 5, the smart contract 16 for avatar NFTs has an NFT creation function 20, an NFT owner acquisition function 21, an all avatar NFT acquisition function 22, an NFT metadata URL acquisition function 23, an NFT owner change function 24, and an item NFT link/unlink function 25.

By a user and/or other systems accessing each of the above functions 20-25 of the smart contract 16 on the above blockchain 11, each of the above functions 20-25 on the smart contract is executed and the execution result will be written to a variable of the smart contract, to thereby enable recording which is practically impossible to modify, in other words, recording as an NFT on the blockchain.

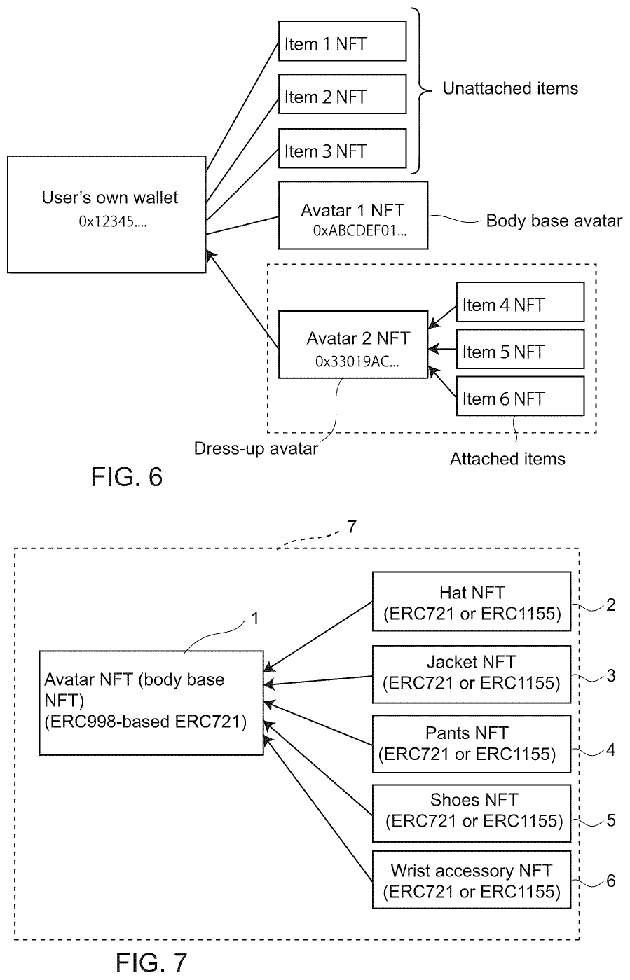

FIG. 6 is a conceptual diagram showing avatar NFTs and item NFTs, which are generated or called by the above functions.

In this figure, a user owns avatars 1 and 2, and items 1-6 attachable to these avatars, wherein these avatars and items are associated with the user's wallet. Here, items 1-3 are items that have not been attached yet, and the avatar 1 is a body base avatar (1 in FIG. 1) before the items are attached. Also, items 4-6 are attached to the avatar 2, and therefore, the avatar 2 is a dress-up avatar (7 in FIG. 3). When items are attached to the body base avatar in this way, the avatar and the items are associated as in a one-to-many parent-child relationship.

Such a parent-child relationship, in this embodiment, is implemented by ERC998-based ERC721 tokens. FIG. 7 is a schematic diagram showing the parent-child relationship between the body base avatar NFT 1 and the dress-up items NFTs 5-6 in the dress-up avatar 7 in this embodiment example.

Variables indicating such NFTs are stored in smart contracts, for example, as shown in FIG. 5.

In other words, the dress-up avatar NFTs (avatar NFT token IDs 1-3) are implemented with an array 28 of ERC721 tokens to determine who owns these dress-up avatar NFTs, and an array 29 of ERC998 tokens to manage the item NFT information associated with the avatar NFTs, respectively, in the one-to-many relationship.

### 7. Smart Contract for Item NFTs

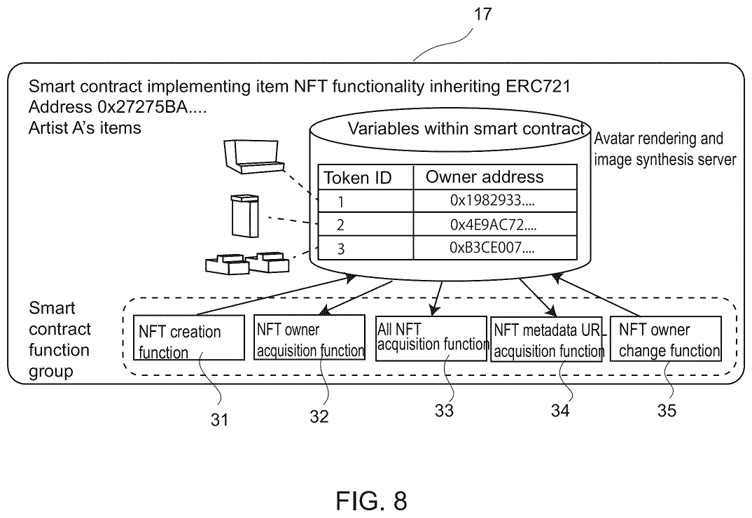

FIG. 8 is a schematic diagram showing the smart contract 17 for item NFTs.

The smart contract 17 for item NFTs, which is prepared for each artist who designed items, has an NFT creation function 30, an NFT owner acquisition function 31, an all avatar NFT acquisition function 32, an NFT metadata URL acquisition function 33, an NFT owner change function 34, and an item NFT link/unlink function 35. Here, an item NFT in this embodiment is an ERC721 (or ERC1155) token for representing an item linked to an avatar NFT.

The items in this embodiment include, but are not limited to, the following types.

(1) Hat

(2) Jacket

(3) Pants

(4) Shoes

(5) Necklace

(6) Left and right wristbands

(7) Hand-held items on both sides (bags, cameras, etc.)

Unlike the avatar NFTs, the above item NFTs are implemented only with the ERC721 functionality, and as described above, are managed with the smart contract by artist. Notably, as described above, in the array for storing item NFTs-which are linked to avatar NFTs, respectively, on a one-to-many basis-managed by the smart contract for avatar NFTs, the smart contract address of each item NFT managed by the contract for item NFTs and its “item NFT token ID” are stored as a set (FIG. 5).

### 8. Metadata for Avatar NFTs and Item NFTs

In the smart contract 16 for avatar NFTs in this embodiment example, a function for returning a URL where metadata associated with the dress-up avatar and the item NFTs are stored (NFT metadata URL acquisition function 23) is stored in the smart contract 16 (FIG. 5).

Here, the metadata for the dress-up item NFTs of this embodiment is adapted so that metadata for the regular NFTs as well as a description for associating the avatar NFT and the item NFTs, and data for generating an image of the avatar wearing the item NFTs are added and stored on the smart contract.

Also, within the metadata of the dress-up avatar NFT, in this embodiment, a name, a description, an avatar image URL, an avatar video URL, an avatar 3D data URL, restrictions such as types of attached items, and other properties such as an avatar size are described.

In addition, since this embodiment provides functionality capable of limiting the NFTs attached to this avatar NFT to item NFTs only, information for this purpose is also recorded in the metadata. Note that, in this case, through settings, NFTs provided by other companies may be also utilized.

On the other hand, as metadata for the item NFTs, in this embodiment, an item name, an item description, an item image URL, an item video URL, an item 3D data URL, restrictions on attachable avatar NFTs, and other properties such as an item size are described and stored.

Note that, unlike the avatar NFT, the item NFTs are implemented only with the ERC721 functionality.

### 9. Avatar Data Generation Server

Next, the avatar data generation server 9 of the present embodiment will be described.

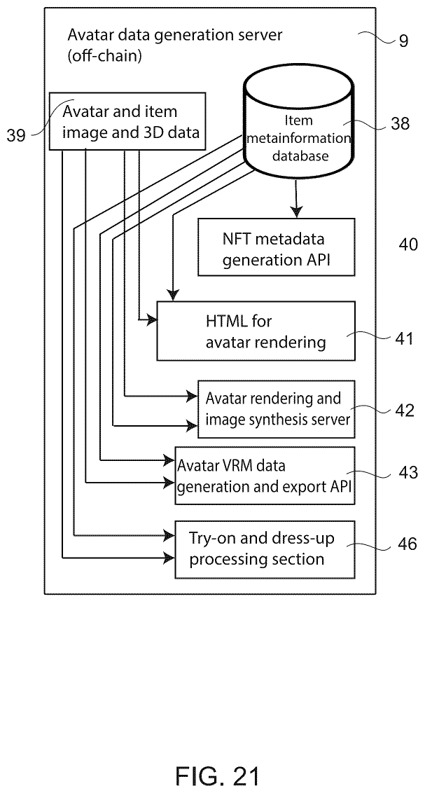

This avatar generation server 9 is provided on the Internet 10 outside of the blockchain network 11 and, as shown in FIG. 21, has a metainformation database 38, an avatar/item image/3D data content storage 39, an NFT metadata generation API 40, an HTML for avatar rendering 41, an avatar rendering and image synthesis server 42, an avatar data generation and export server 43, and a try-on and dress-up processing section 46.

They will be described below.

### 10. Metadata Storage Database

The metadata storage database 38 stores the avatar and item metadata described above. This metadata is retrieved from here when a metadata retrieval request is made externally to the NFT metadata generation API 40, and provided externally.

### 11. Avatar/Item Image/3D Data Content Storage

This avatar/item image/3D data content storage 39 stores contents such as dynamically generated images, 3D data, and/or videos of avatars and items. When a particular avatar is dressed up or as described below, the avatar's image and 3-dimensional data are updated to those after the change of clothes and/or items.

### 12. NFT Metadata Generation API

This API is configured to return metadata such as NFT names and descriptions, and avatar/item data information such as images and videos in JSON format.

In other words, when a service or an app such as the NFT marketplace tries to display NFT information, images, or videos on a user's terminal, an NFT marketplace server and app will call the smart contract's NFT metadata URL acquisition function, which will obtain a URL from which information on the NFT may be obtained. This URL is an address that refers to the NFT metadata generation API, and by calling this URL from the above service or app, NFT metadata information may be obtained in JSON format from this avatar generation server, enabling the display of NFT names, images and videos in the service or app.

In other words, as described above, the NFT smart contracts 16 and 17 are capable of setting and storing a metadata acquisition destination URL for acquiring metadata specific to each NFT.

And this API 40 returns metadata for NFTs obtained from the avatar/item metainformation database 38 when a request is made with a collection ID and an avatar/item NFT ID. Therefore, the URL of this API 40 is set as the metadata URL of NFTs.

Then, when a desired NFT is displayed in an NFT marketplace such as OpenSea, the metadata obtained from this metadata API 40 is used as a basis to display the desired avatar or item.

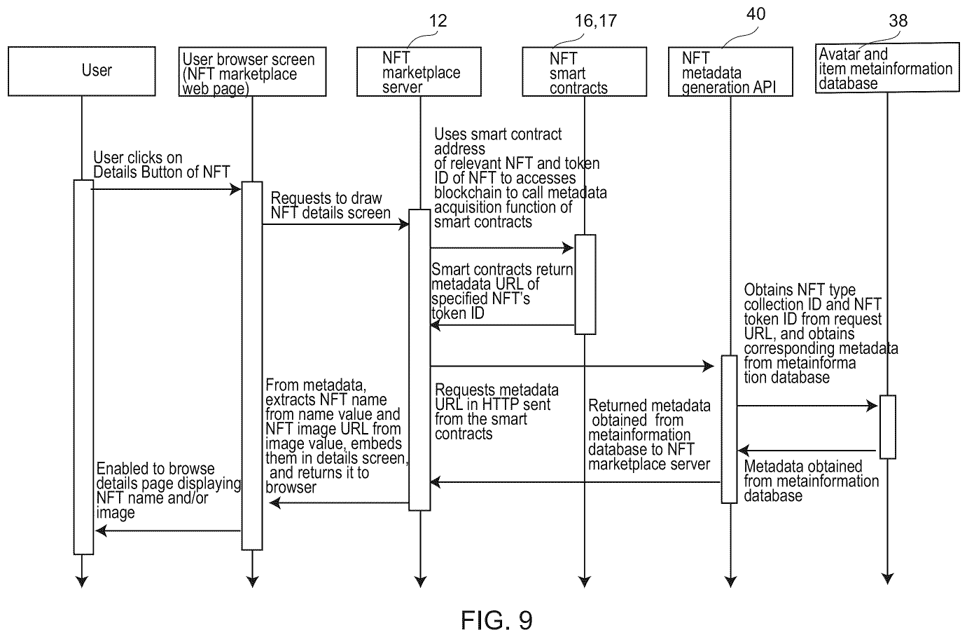

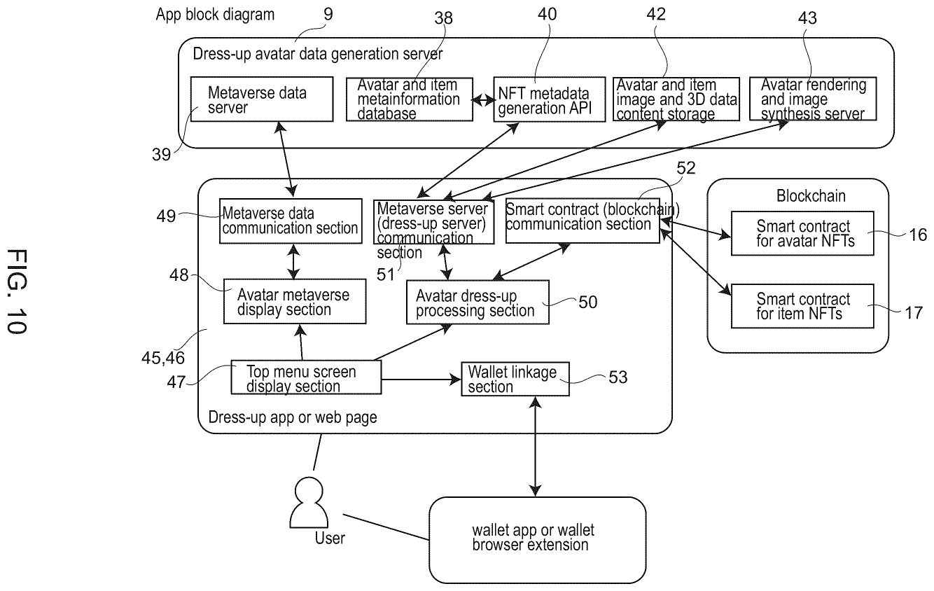

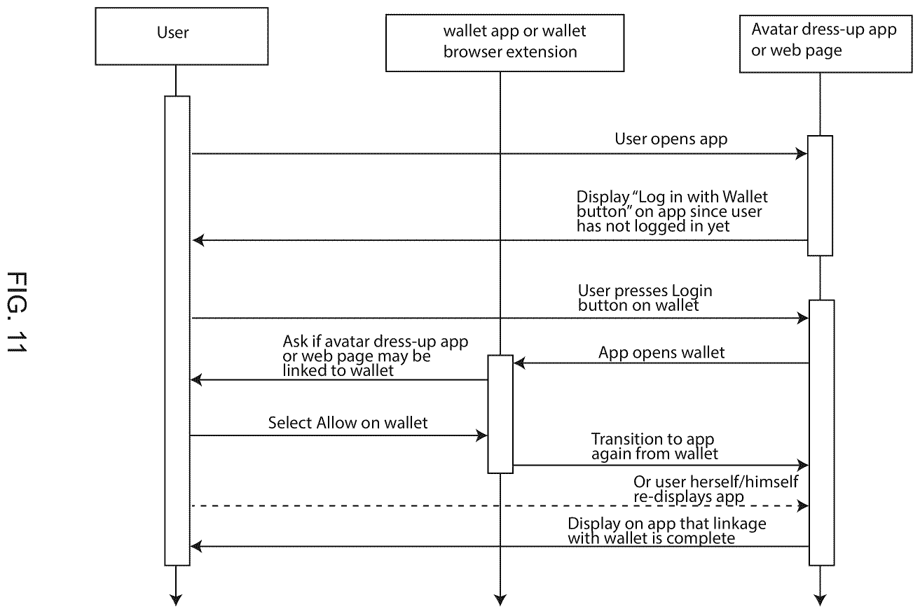

FIG. 9 shows a sequence for up to displaying an avatar NFT or an item NFT in the NFT marketplace 12.

That is, first, the user clicks on a Details button to open the NFT details screen in the NFT marketplace 12. Then, a request for a page is sent to the NFT marketplace server 12 by the browser, and the NFT marketplace server 12 first calls the metadata URL acquisition function of the NFT's smart contracts 16 and 17 to acquire the metadata URL of the corresponding NFT ID. The NFT marketplace server 12 sends a GET request via HTTP to that metadata URL.

That metadata URL is the URL of the NFT metadata generation API 40, and the metadata generation API 40 obtains three URL parameters: TYPE (avatar or item), COLLECTION_ID (ID set for each smart contract), and NFT_ID, and utilizes the information to obtain the metadata JSON of the corresponding NFT from the metainformation database 38. The metadata JSON is returned to the NFT marketplace server 12, and based on that information, the NFT name and/or the URL of the NFT image and/or video (HTML for avatar rendering 41) are incorporated and the NFT details screen is constructed.

Example: The avatar metadata API 40 is specified as the following three URL parameters: TYPE (avatar or item), COLLECTION_ID (ID set for each smart contract), and NFT_ID.

### https://API.metabaword.com/v1/TYPE/COLLECTION_ID/avatar/NFT_ID

The following is a metadata URL for an avatar type, collection ID: shimeji, and NFT ID: 1.

https://API.metabaword.com/v1/avatar/shimeji/avatar/1

### 13. HTML Server for Avatar Rendering

The avatar NFT is displayed with four types in this embodiment: image, video, 3D data, and HTML.

This HTML server 41 for avatar rendering is used to display the above in HTML.

This HTML server 41 for avatar rendering provides a page that may be embedded in an <iframe> within a web page of the NFT marketplace 12, basically displaying the avatar in 3D using WebGL and allowing the user to perform simple operations.

Mainly, this HTML is utilized for display in the NFT marketplace 12 such as OpenSea where HTML embedding is enabled.

### 14. Avatar Rendering and Image Synthesis Server

This server 42 is, when outputting an avatar NFT as an “image” and/or a video among the avatar NFT display methods, capable of rendering the 3D data 39 of an avatar and/or an item in the server and outputting the data as an image or a video.

Each time an avatar NFT configuration is changed, a rendering is performed and the image is stored in the above storage 39.

### 15. Avatar data generation and export server

This server 43 is for generating avatar data that may be used in various metaverses.

In other words, in general, each metaverse has different available 3D formats and/or functional limitations of 3D data. Therefore, this server 43 provides a function for converting the 3D data of an avatar NFT/item NFT to a 3D format according to each metaverse to export it, or vice versa, converting the 3D data to import it. This converted data is stored in the 3D data storage 39 and a URL is generated for retrieving it.

### 16. Dress-up App

Shown in the left center of FIG. 10 is a schematic configuration diagram showing a dress-up app 45 installed on the user's smartphone or the try-on and dress-up processing section 46 of the server 9.

This dress-up app 45 (or try-on and dress-up processing section 46 (hereinafter collectively referred to as dress-up app 45)) has a top/menu screen display section 47, an avatar metaverse display section 48, a metaverse data communication section 49, an avatar dress-up processing section 50, a metaverse server (dress-up server) communication section 51, a smart contract communication section 52, and a wallet linkage section 53.

The configuration and function of each of the components 47-53 of this dress-up app 45 will be discussed below through descriptions of operations of changing clothes/items of an avatar in this system, generating three-dimensional data of the dress-up avatar, generating images and videos, and forming the NFT of the dress-up avatar.

### 17. Operations

### (17-1) Purchase of Avatar NFTs and Item NFTs

First, the user logs into the NFT marketplace server 12 such as OpenSea with the user's wallet to display and purchase avatars and items. FIG. 9 shows this process of displaying avatars and items.

In other words, this process is performed as follows.

Step 1: The user clicks on the NFT Details button with the NFT marketplace 12 interface displayed on the user's browser.

Step 2: The user sends a request to draw an image of the NFT details screen to the NFT marketplace 12.

Step 3: The NFT marketplace 12 utilizes the smart contract address of the relevant NFT and the token ID of the NFT to accesses blockchain 2 in order to call the metadata acquisition function of smart contracts 16 and 17.

Step 4: The smart contracts 16 and 17 on blockchain 2 return the metadata URL of the specified NFT's token ID.

Step 5: The NFT marketplace 12 sends a request to the NFT metadata generation API 40 with the metadata URL in HTTP sent from the smart contracts 16 and 17.

Step 6: The NFT metadata generation API 40 obtains an NFT type collection ID and an NFT token ID from the request URL, and obtains corresponding metadata from the metainformation database.

Step 7: The NFT metadata generation API 40 returns metadata obtained from the metainformation database 38 to the NFT marketplace server.

Step 8: Based on the metadata, the NFT marketplace 12 extracts a name of the NFT from a name value and an URL of the NFT image from an image value, embeds them in the details screen, and returns it to the browser.

Step 9: The user may refer to the data in the avatar and item image 3D data storage 39 on the browser, and view a details page displaying the name and/or image of the NFT.

Here, avatar NFTs are sold with no item NFT linked thereto at all (body base avatar) or with an item NFT or item NFTs linked thereto in advance (dress-up avatar).

After the user purchases NFTs, avatar NFTs and/or item NFTs will be linked to the user's wallet.

### (17-2) Launch the Dress-up App

After purchasing an NFT for an avatar or item, the user launches the dress-up app 45 or browser on the user's smartphone and, according to a process shown in FIG. 11, may log into the app with the wallet from the time of NFT market purchase described above.

In other words, this process executes the following steps.

Step 1: The user opens the app, or connects to the server 9 via a browser.

Step 2: If the user has not yet logged in, the server 9 or the app displays a “Login with Wallet button.”

Step 3: The user presses the Login button on the user's wallet. This login is provided by an app extension function or a browser extension function.

Step 4: The wallet linkage section 53 app or browser opens the wallet.

Step 5: The user is asked if the avatar dress-up app or web page may be linked to the wallet.

Step 6: The user selects permission on the wallet.

Step 7: The user is directed from the wallet to the app again, or the user himself/herself redisplays the app.

Step 8: The wallet linkage section 53 completes the linkage and displays on the app or the browser that the linkage with the wallet is complete. This allows the user to buy, sell and dress up with NFTs using the wallet.

### (17-3) Select an Avatar to Dress Up

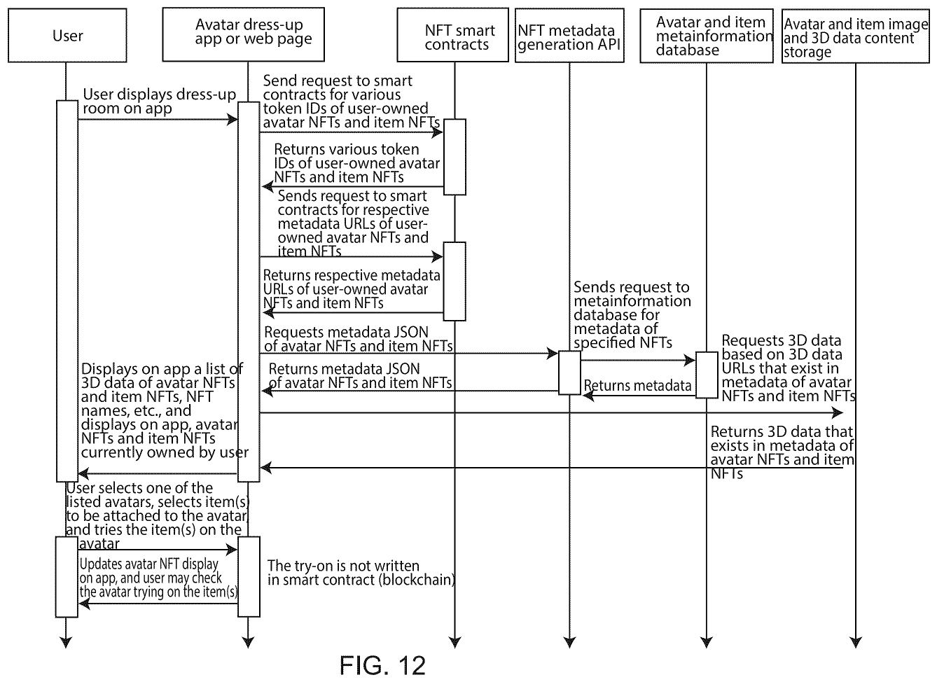

After logging into the app, through a process shown in FIG. 12, the top menu screen display section 47 and the avatar metaverse display section 48 and the avatar dress-up processing section 50 display with images a list of avatar NFTs that the user has purchased on the user's screen. The user selects an avatar that the user wishes to dress up.

In other words, in this process, the following steps are executed.

Step 1: The user launches a dress-up room provided by the server 9 either on the app on the user's terminal, or on the browser.

Step 2: The user sends a request for various token IDs of avatar NFTs and item NFTs that the user owns, from the app or the browser to the smart contracts 16 and 17 on the blockchain network.

Step 3: The blockchain network returns to the user the various token IDs of the avatar NFTs and the item NFTs that the user owns.

Step 4: A request for respective metadata URLs of the user-owned avatar NFTs and item NFTs is sent to the smart contracts 16 and 17.

Step 5: The respective metadata URLs of the user-owned avatar NFTs and item NFTs are returned.

Step 6: A request for the metadata JSON for the avatar NFTs and item NFTs is sent to the NFT metadata generation API 40.

Step 7: The NFT metadata generation API 40 sends a request for metadata for the specified NFTs to the metainformation database 38.

Step 8: The metadata is returned in response to the above request.

Step 9: The metadata JSON for the avatar NFTs and item NFTs is returned to the user.

Step 10: The user sends a request for 3D data (including image and video data) to the server 9 based on the 3D data URLs that exist in the metadata of the avatar NFTs and item NFTs.

Step 11: The server returns the 3D data that exists in the metadata of the avatar NFTs and item NFTs from the 3D data content storage 39.

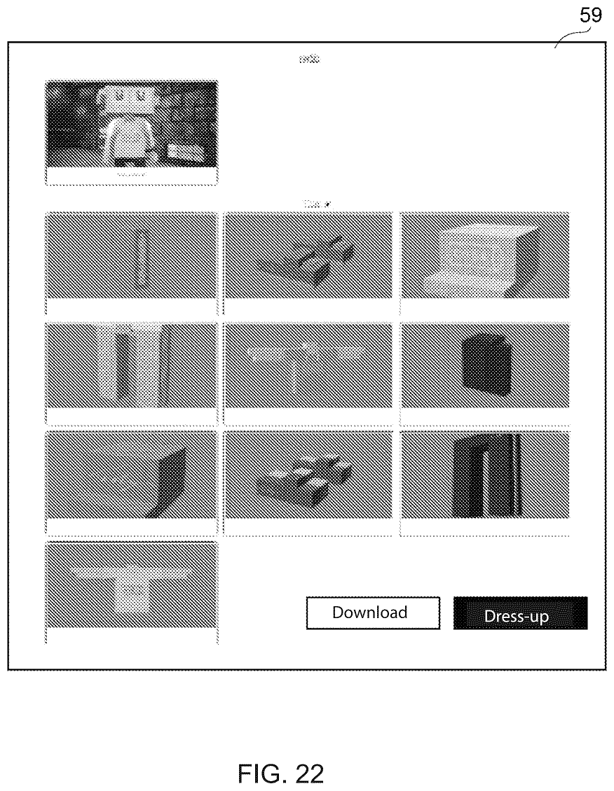

Step 12: The user displays on the app a list of the 3D data (image and video data) of the avatar NFTs and item NFTs, names of NFTs, and the like; and displays on the app 45 or the browser the avatar NFTs and item NFTs currently owned by the user. Note that, in the following, the interface shown in FIG. 22 and below is, as described above, generated by the top menu screen display section 47, the avatar metaverse display section 48, and the avatar dress-up processing section 50.

First, FIG. 22 is an interface 59 that displays a list of images of an avatar NFT and item NFTs owned by the user. These images may be videos, or they may be dynamically displayed by rendering 3D data.

Step 13: Next, the user selects one of the listed avatars (only one is shown in FIG. 22, but more than one may be displayed as well), selects an item or items the user desires the avatar to wear, and tries the item or items on the avatar. The try-on is not written in the smart contract (blockchain). This saves so-called gas.

Step 14: The display of the avatar NFT on the app is updated, and the user may check the avatar with the tried-on item/items.

### (17-4) Select an Item/Items to Try on, And Try it/Them on in the Fitting Room (Avatar Dress-Up Processing Section 50)

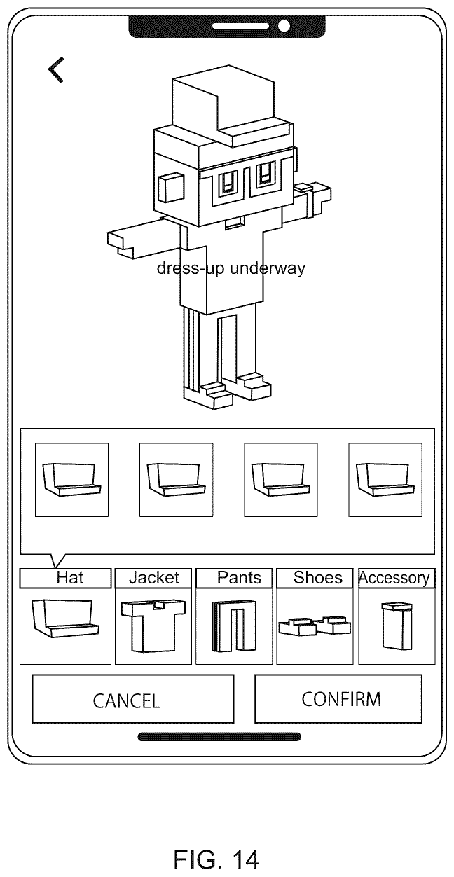

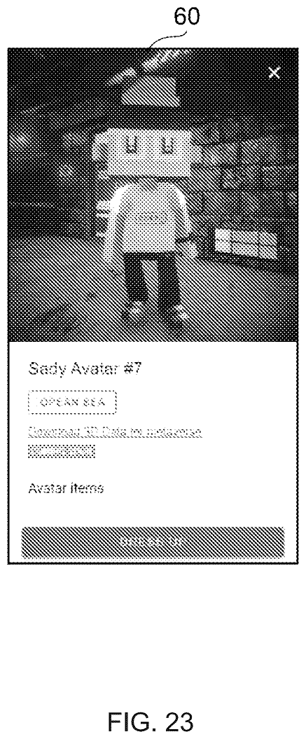

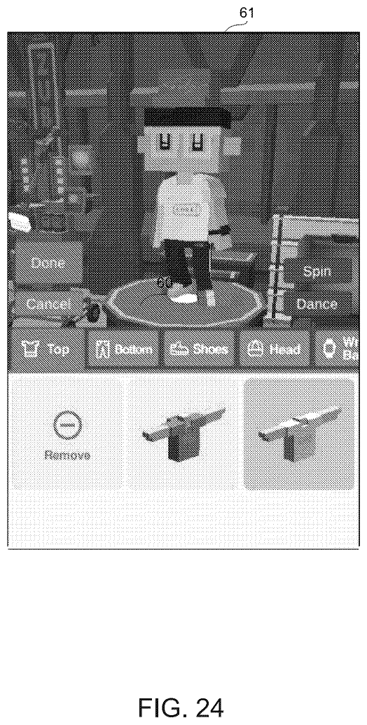

FIG. 23 is an interface 60 displayed as a pop-up when an avatar is selected in Step 13 above. Pressing the “Dress UP” button on this interface provides the interface as shown in FIG. 14, where the user may dress up or change items on the avatar. FIG. 24 is the actual app interface 61 of that in FIG. 14.

In this interface, the avatar who is dressed up is displayed in the upper portion, and in the lower portion, a list of the user's own item NFTs are displayed as images by item type. When the user selects an item NFT from this list, the display in the upper portion is updated to show the item as if it were actually being tried on the avatar. This display update is provided by the avatar rendering image synthesis server 42 using data stored in the 3D data content storage 39.

In this example, the avatar shown in FIG. 24 is a “dress-up avatar” with some items already attached thereto. Therefore, in order to attach a new item of the same type to the avatar, it is necessary to remove the item already attached and attach the new item.

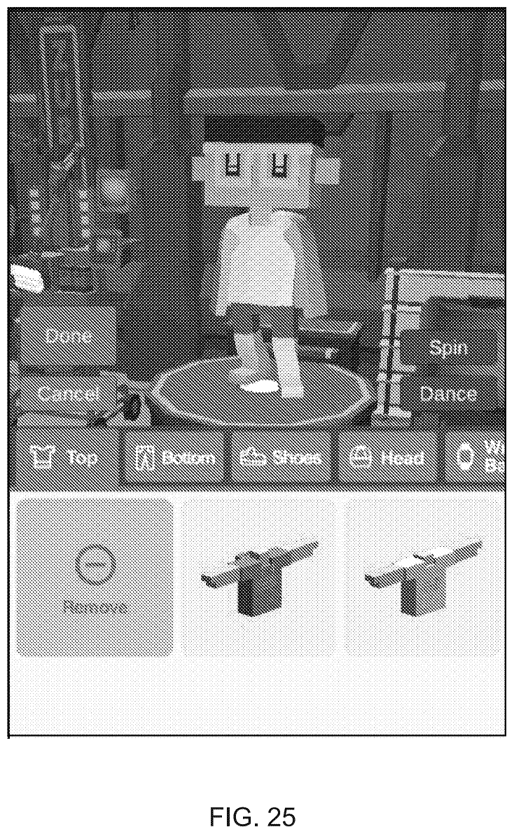

FIG. 25 shows the avatar shown in FIG. 24 with all attached items removed by pressing a “Remove” button. This example shows the underwear state, but other states may be possible with only some item or items, for example, a jacket, is removed.

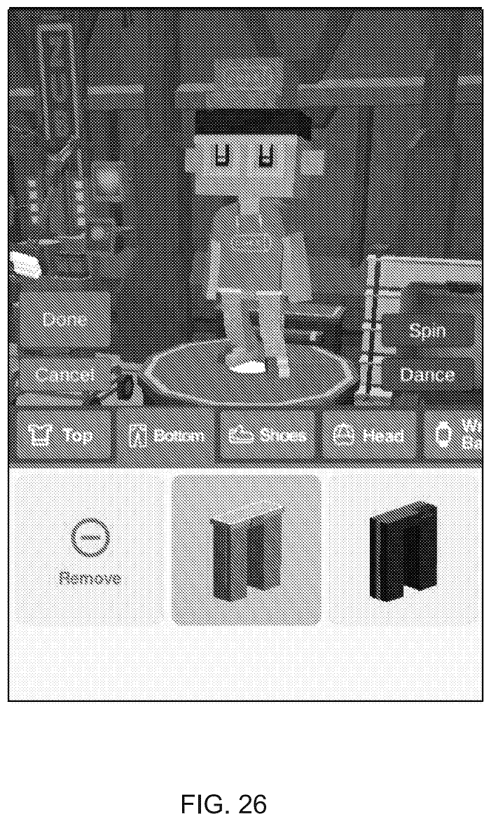

FIG. 26 shows the avatar shown in FIG. 25 with new items attached.

At this timing, the avatar and the items are not yet linked in the blockchain, and the user may check the image of the avatar wearing the items without paying for the gas (FIG. 12). Therefore, the user may enjoy trying on various items by attaching and removing them.

### (17-5) Finish the Avatar'S Try-on and Finalize the Avatar'S Outfit

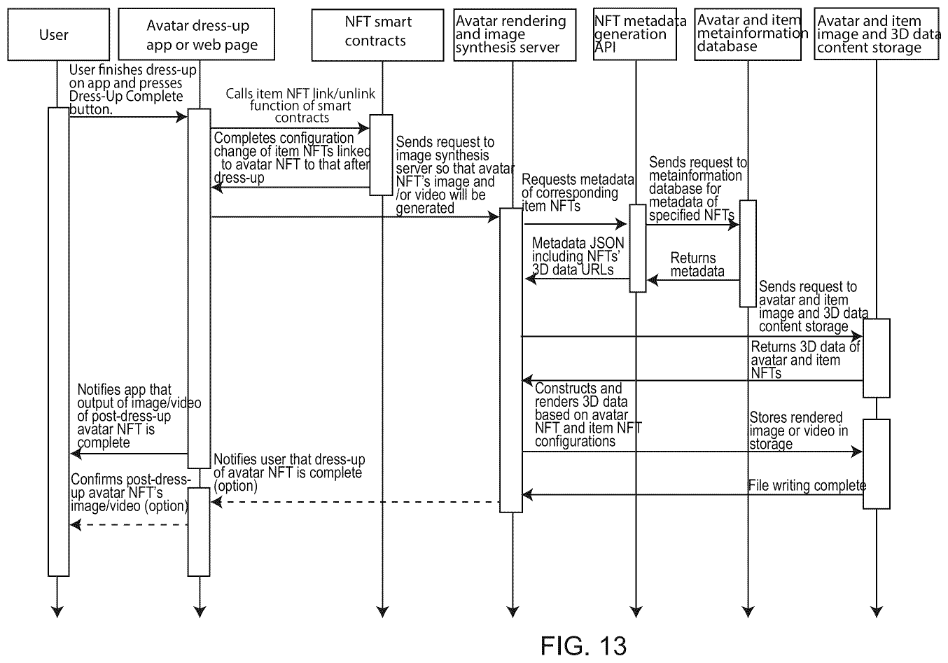

After the try-on is complete and the avatar's dress-up is completed, pressing a Done button shown in FIG. 26 (“Decide” button at the bottom of the screen shown in FIG. 14) updates linkage between the avatar NFT and the item NFTs in the blockchain through the process shown in FIG. 13.

In other words, this process is achieved by the following steps.

Step 1: The user finishes changing items on the app and presses the Dress-Up Complete (Done) button.

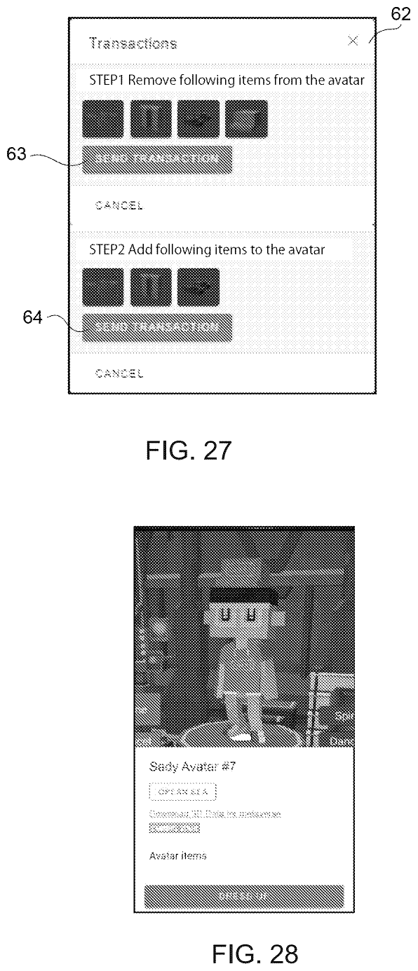

Step 2: The smart contract communication section 52 of the app 45 generates an interface (62 in FIG. 27) for letting the user confirm the transaction, and by the user operating Transaction buttons 63 and 64, the item NFT link/unlink function 25 of the smart contracts 16 and 17 is called to issue the NFT unlink command according to the above dress-up.

Step 3: The above item NFT link/unlink function 25 completes the change of the configuration of item NFTs linked to the avatar NFT to the one after the change of items.

Step 4: A request is sent to the image synthesis server 42 so that the avatar NFT's image and video will be generated.

Step 5: The synthesis server 42 sends a request for metadata of the corresponding item NFTs to the metadata generation API 40.

Step 6: The API 40 sends a request for metadata for the specified NFTs to the metainformation database 38.

Step 7: The metastate database 38 returns the metadata.

Step 8: The database 38 returns metadata JSON containing URLs of the NFT 3D data to the synthesis server 42.

Step 9: Based on the above URLs, the synthesis server 42 sends a request for 3D data to the avatar and item image and 3D data content storage 39.

Step 10: The storage 39 returns the 3D data of the avatar and item NFTs to the synthesis server 42.

Step 11: The synthesis server 42 constructs and renders 3D data based on the avatar NFT and item NFT configurations.

Step 12: The synthesis server 42 stores the rendered image or video in the storage 39.

Step 13: The storage 39 notifies the synthesis server 42 of the completion of file writing.

Step 14: The synthesis server 42 notifies the app that the output of the image/video of the post-dress-up avatar NFT is complete.

Step 15: The user confirms the image/video of the post-dress-up avatar NFT.

This dress-up avatar image is retrieved from the avatar and item image and 3D data content storage 39 and displayed.

Thus, the avatar NFT and item NFTs were originally all linked to the user's own wallet, but by pressing the Transaction button or buttons, the item NFTs are unlinked from the user's wallet and linked to the avatar NFT.

Therefore, it is only at this point that the blockchain is written into and the gas fee is generated.

Note that, in order to execute the change of items on an avatar that has already been dressed up, at least two writings, one for item removal and one for item attachment, must be performed. FIG. 27 shows the interface 62 for executing these writings of this embodiment.

In other words, after changing the dress-up avatar shown in FIG. 24 to the one shown in FIG. 26, pressing the Done button displays the pop interface 62 shown in FIG. 27 on the app.

In this case, in this embodiment, two write transactions of Step 1 and Step 2 shown in this figure are performed to the blockchain.

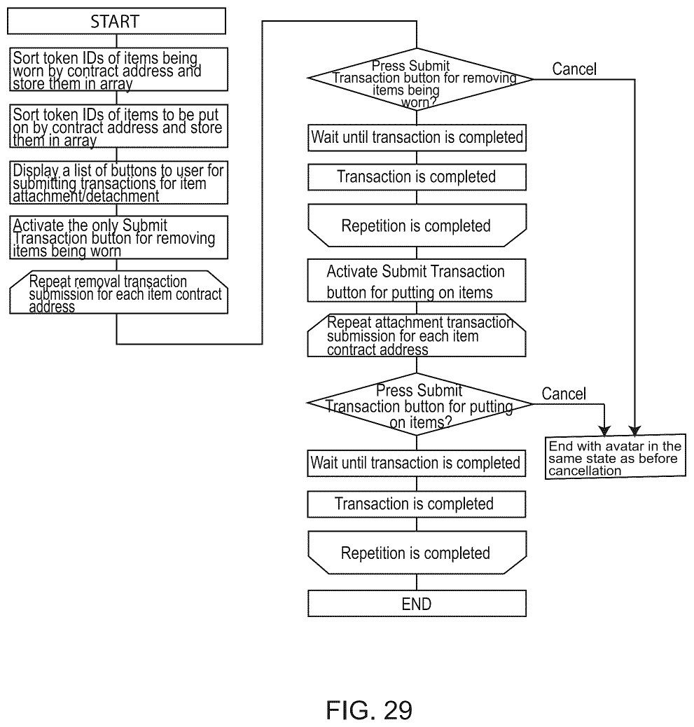

In Step 1, the write transaction is performed from the state in FIG. 24 to that shown in FIG. 25, and in Step 2, the write transaction is performed from the state in FIG. 25 to that shown in FIG. 26. Note that, in this embodiment, in order to prevent the Step 2 transaction from being executed before the Step 1 transaction is executed, the Transaction button 64 of Step 2 is not activated until the Transaction button 63 of Step 1 is pressed and the writing is completed (see FIG. 29) (note that these buttons 63 and 64 may also be displayed as links).

FIG. 29 is a flowchart showing this process.

In other words, the actual dress-up includes cases where different items are in the same contract and cases where different items are in a plurality of different contracts.

For example, items of different types, e.g., a T-shirt and shoes, may belong to the same contract. If dress-up-related items are spread over several different contracts, a dressing and undressing transaction will occur for each contract.

In other words, for items in the same contract, they may be merged into a single transaction. However, even in that case, the removal and attachment will be separate transactions.

Thus, when all transactions are executed, as shown in Steps 11 and 12 of FIG. 13 above, 3D data is constructed by the avatar rendering and image synthesis server 42 based on the configuration of the avatar NFT and the item NFTs after the dress-up, and the images and videos are rendered.

This will also update thumbnails of the dress-up NFTs, as shown in FIG. 28. Accordingly, the interface shown in FIG. 22 is also updated with the post-dress-up thumbnails, and the thumbnail images displayed on the NFT marketplace are also switched to the new ones.

Notably, as shown in the flowchart in FIG. 29 above, dress-up may be canceled before its completion. That is, if the dress-up spans a plurality of transactions, it may be canceled without any of the transactions executed, or after one transaction is executed, the rest of the transactions may be canceled.

In that case, since the dress-up is interrupted before the cancellation, the avatar rendering and synthesis server renders the 3D data, images and videos in that state and stores them in the avatar and item image and 3D data content storage.

Also, it may be that writing to the blockchain is not performed when the “Decide/Done” button is tapped, but the avatar/item link may be written first to the app's database so that the avatar dressed up in the app's metaverse may be used in the app's metaverse. In that case, a “Write to Blockchain” button may be provided separately on a user screen or the like to thereby allow the user himself/herself to write in the blockchain which will incur the gas fee.

In this implementation, the images, videos, and 3D data for the metaverse stored in the server 9 are updated when the blockchain is written into to change the avatar NFT and/or item NFT configuration. At that time, the avatar rendering and image synthesis server and/or the avatar data generation and export server automatically operate, and based on the current avatar NFT configuration, images, movies and/or 3D data for the metaverse are automatically exported, and the generated images, movies and/or 3D data are stored in the above storage. Then, subsequently, using this updated data, the post dress-up avatar may be displayed.

### (17-6) Acquisition of 3D Data for Use in Other Metaverses

After dressing up the avatar, downloading 3D data for the metaverse is required when that avatar (dressed-up avatar) is used in other metaverses.

To accommodate this, in the present embodiment, upon logging in from the app or to the website provided by the metaverse server 9 with the wallet, a list of avatar NFTs that the user currently owns is displayed by way of images (FIG. 22). Clicking on a desired avatar image displays a link to download the avatar's 3D data for the metaverse, through which link the download is enabled.

This link, which is provided by the export API 43, is separated for each of various metaverses, such as VRChat and/or Cluster, and is configured so that the 3D data link for the desired metaverse may be clicked for download.

### 18. Changes in Smart Contract Arrays and Variables Before and After Avatar Dress-up

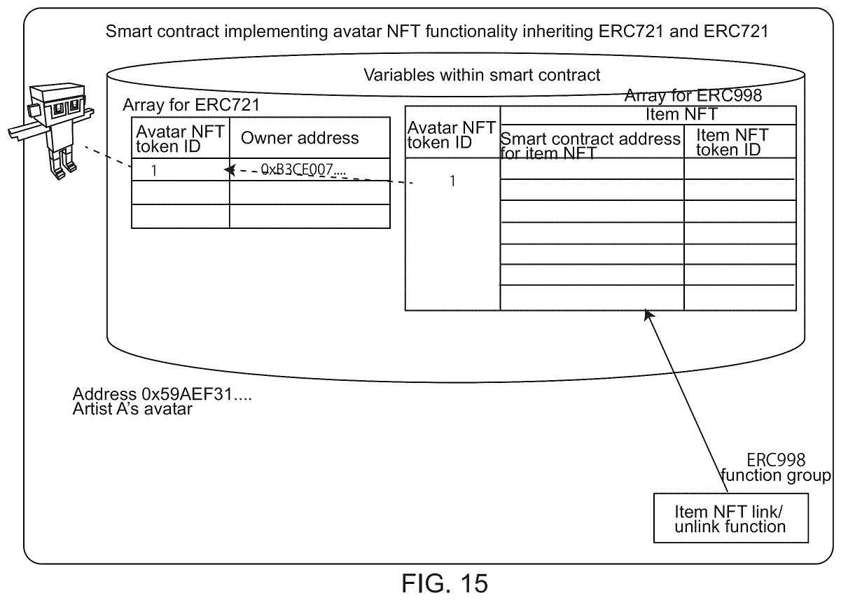

Next, the rewriting of smart contract variables before and after avatar dress-up performed by the avatar dress-up processing section 50 and the smart contract communication section 52 will be specifically described with reference to FIGS. 15-17 and FIGS. 18-20.

### (18-1) Before Dressing Up Avatar NFT

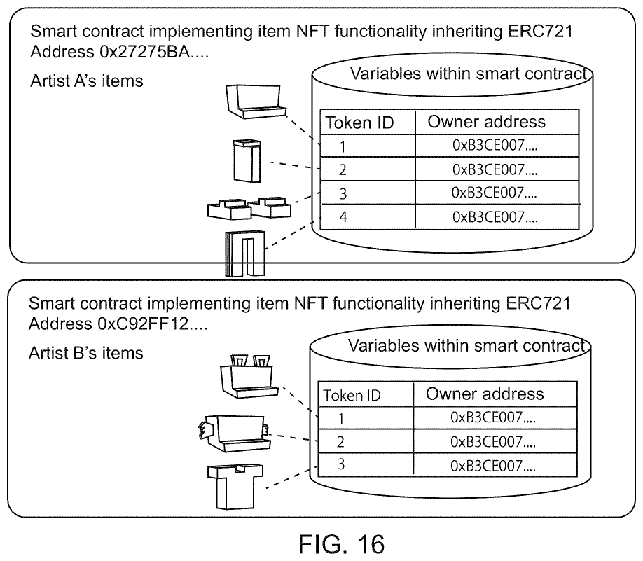

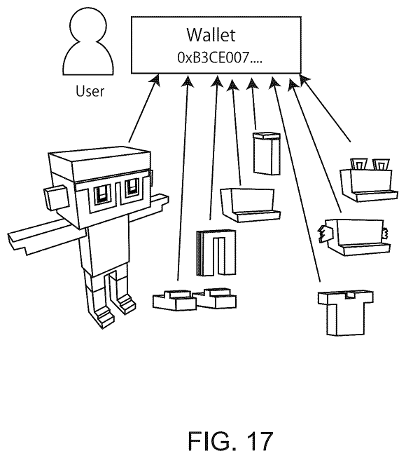

FIG. 15 shows the smart contract for an avatar NFT before dress-up, FIG. 16 shows the smart contract for item NFTs before dress-up, and FIG. 17 shows a display of the avatar and the items before dress-up.

In this state, the user has a wallet with a wallet address 0xB3CE007 . . . and the wallet is linked with an avatar NFT not wearing anything yet (body base avatar), and total of seven item NFTs, which exist in the two smart contracts with smart contract addresses 0x27275BA . . . and 0xC92FFF12 . . . .

Looking at the avatar NFT, the array for ERC998 contains nothing, indicating that no item NFT is linked to the avatar in this avatar NFT smart contract (FIG. 15). The array for ERC721 contains data indicating that a token ID 1 of the avatar NFT is linked to the user.

On the other hand, as for the item NFTs, as indicated in FIG. 16, all item NFTs in the two smart contracts are owned by the user.

### (18-2) After Dressing Up Avatar NFT

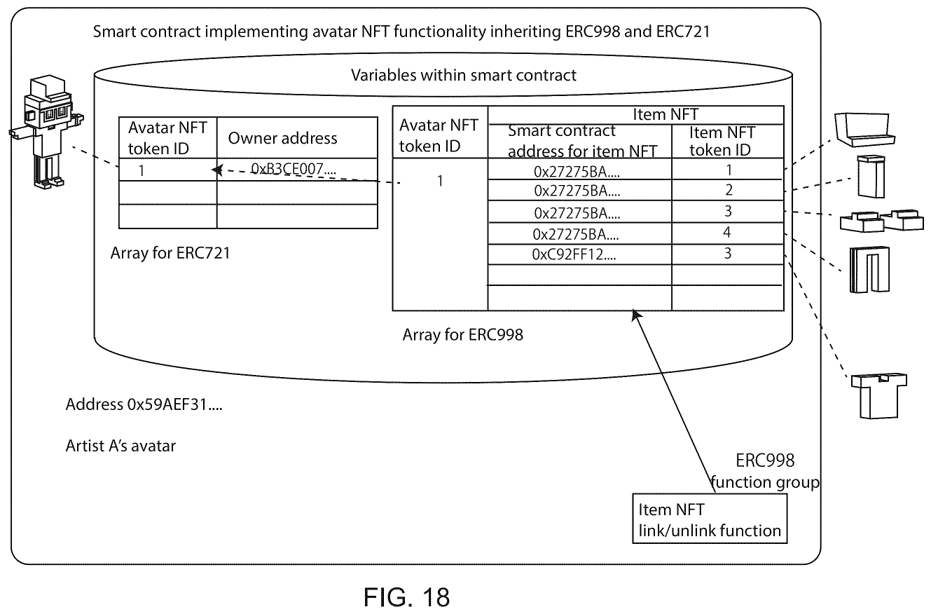

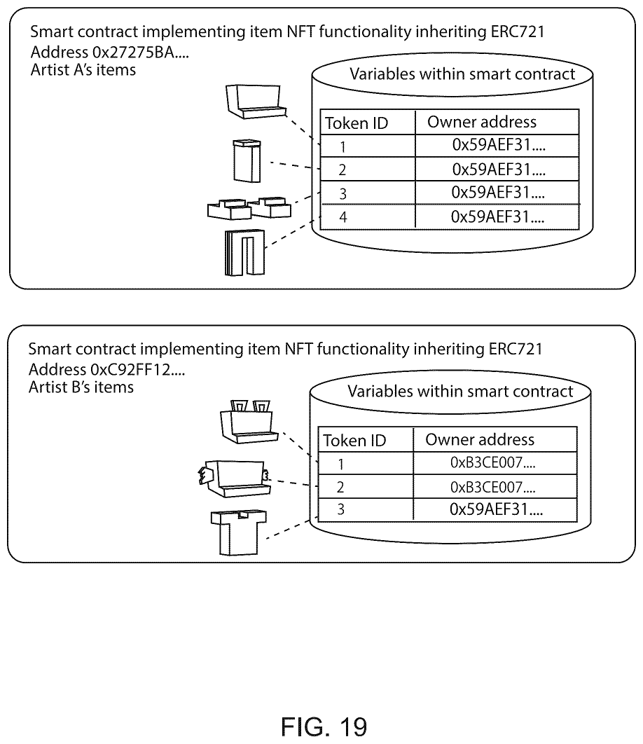

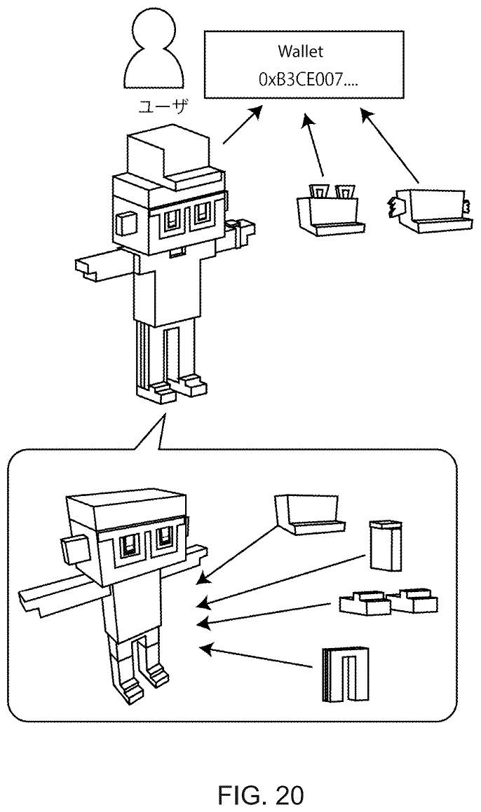

FIG. 18 shows the smart contract for the avatar NFT after dress-up, FIG. 19 shows the smart contract for item NFTs after the dress-up, and FIG. 20 shows a display of the avatar and the items after the dress-up.

In other words, from the above pre-dress-up state, assume that the user in the app's fitting room dresses the avatar with items with token IDs 1, 2, 3, and 4 with a smart contract address 0x27275BA . . . and an item NFT with token ID 3 with a smart contract address 0xC92FF12 . . . , and presses the Decision button (the Done button and the Transaction buttons (see FIG. 26 and FIG. 27)).

In that case, firstly, ownership addresses of all the item NFTs to be worn will be changed from the user's wallet address to the smart contract addresses of the item avatar NFT. By doing this, the ownership of the item NFTs will be transferred to the avatar NFT (the smart contract of the avatar NFT).

Subsequently, the “item NFT link/unlink function” of the smart contract of the avatar NFT is called, and all smart contract addresses of the item NFTs put on the avatar NFT and the token IDs of the item NFTs are respectively saved as a set in an array for ERC998.

With this data update, the NFTs owned by the user will be only the avatar NFT 1 and the item NFTs (the smart contract address 0xC92FF12 . . . ) of token IDs 1 and 2.

Then, based on the rewritten avatar NFT, the above server metadata and the image, video, and three-dimensional shape data will be updated, and the post-dress-up avatar will be displayed as shown in FIG. 20 and FIG. 28.

Although one embodiment of the present invention has been described, the present invention is not limited to the above one embodiment, and various changes and modifications may be made without departing from the scope and spirit of the invention.

For example, in the above one example, the non-attachable model, which is the object of attaching and detaching items, was an avatar, but it is not limited to this.

For example, it is applicable to game items other than avatars, for example, where various part items are attached to and detached from a passenger vehicle.

Also, in the one embodiment above, each component requirement of the present invention is implemented by the API and the like, but any means may be possible as long as they perform the same function.

Further, in the above example, respective components, including the item metainformation database 38 and/or the avatar and item image and 3D data storage 39, were provided on the server 9, but they may be distributed and provided across a plurality of servers and/or servers of other service providers. In other words, the images and 3D data of items to be attached to the avatar may be supplied by data servers of other service providers. The same also applies to metainformation stored in the item metainformation database.

### Description of the Reference Numbers

1: Body base avatar
2: Hat
3: Watch
4: Shoes
5: Pants
6: Shirt
7: Dress-up avatar
8: Dress-up avatar data generation server
9: Avatar data generation server
11: Blockchain network
12: NFT marketplace server
13: Web service
14: Metaverse
16: Smart contract for avatar NFTs
17: Smart contract for item NFTs
20: Avatar NFT creation function
21: NFT owner acquisition function
22: All avatar NFT acquisition function
23: NFT metadata URL acquisition function
24: NFT owner change function
25: Item NFT link/unlink function
28: Array of ERC721 tokens
29: Array of ERC998 tokens
30: NFT creation function
31: NFT owner acquisition function
32: All avatar NFT acquisition function
32: All NFT acquisition function
33: NFT metadata URL acquisition function
34: NFT owner change function
35: Item NFT link/unlink function
38: Avatar and item metainformation database
39: Avatar and item image and 3D data content storage
40: NFT metadata generation API
41: HTML for avatar rendering
42: Avatar and item image and 3D data content storage
42: Avatar rendering and image synthesis server
43: Avatar data generation and export server
43: Avatar VRM data generation and export API
45: Dress-up app
46: Try-on and dress-up processing section
47: Top menu screen display section
48: Avatar metaverse display section
49: Metaverse data communication section
50: Avatar dress-up processing section
51: Metaverse server (dress-up server) communication section
52: Smart contract communication section
53: Wallet linkage section
59: Interface
60: Interface
61: App interface
62: Pop interface
63: Transaction button
64: Transaction button

What is claimed is:

1. A method for processing, by a computer, attachment and removal of item for a to-be-dressed NFT model, comprising steps of:
storing, by the computer, data for displaying a model to be dressed;
storing, by the computer, data for displaying an item for attaching to the model;
providing, by the computer, a smart contract for the model on a blockchain;
providing, by the computer, a smart contract for the item on the blockchain;
referencing, by the computer, the smart contract for the model and the data for displaying the model, and displaying the model to a user;
referencing, by the computer, the smart contract for the item and the data for displaying the item, and displaying the item to the user;
providing the user, by the computer, with a try-on and removal interface for trying the item on and removing the item from the model;
providing the user, by the computer, with an interface for allowing the user to decide on the item to attach to the model; and
executing, by the computer, based on the user's decision on the item attachment to or detachment from the model, a transaction on the blockchain for associating or disassociating an item NFT for the attached or detached item with or from a model NFT for the smart contract for the model.

2. The method of claim 1, wherein
the model is an avatar.

3. The method of claim 1, further comprising a step of
updating the data for displaying the model after the item attachment or detachment based on the execution of the transaction for the smart contract for the model.

4. The method of claim 1, further comprising a step of
providing a user interface for displaying the model after the item attachment or detachment based on the data for displaying the model after dress-up.

5. The method of claim 1, wherein
the step of executing the transaction executes both or either one of: a transaction for changing an ownership address of the item NFT of the item to be attached to the model from the user's wallet address to a smart contract address of an item avatar NFT, and/or a transaction for changing an ownership address of the item NFT of the item to be detached from the model from a smart contract address of an item avatar NFT to the user's wallet address.

6. The method of claim 5, wherein
when there is an item to be detached from the model and an item to be attached to the model,
after executing the transaction for changing an ownership address of an item NFT of the item to be detached from the model from a smart contract address of an item avatar NFT to the user's wallet address,
execution of the transaction for changing an ownership address of an item NFT of the item to be attached to the model from the user's wallet address to a smart contract address of an item avatar NFT is permitted.

7. The method of claim 5, wherein
the step of providing the user, by the computer, with an interface for allowing the user to decide the item to attach to the model
displays a button or a link on the interface for allowing the user to execute the transaction for attaching or detaching the item for each smart contract for the item.

8. The method of claim 7, wherein
the button or the link for allowing the user to execute the transaction for attaching an item
is activated or displayed after the transaction for detaching an item is executed.

9. The method of claim 2, further comprising a step of
generating, by the computer, the data for displaying the model for use in a specific metaverse, and allowing its download.

10. A system for processing, by a computer, attachment and removal of item for a to-be-dressed NFT model,
wherein there are provided on a blockchain, a smart contract for the model and a smart contract for attached/detached items,
said system comprising:
a model display data storage section for storing, by the computer, data for displaying a model for dress-up;
an item display data storage section for storing, by the computer, data for displaying an item for attaching to the model;
a model display section for referencing, by the computer, the smart contract for the model and the data for displaying the model, and displaying the model to a user;
an item display section for referencing, by the computer, a smart contract for the item and the data for displaying the item, and displaying the item to the user;
a try-on and removal interface providing section for providing the user, by the computer, with a try-on and removal interface for trying the item on and removing the item from the model;
a decision interface providing section for providing the user, by the computer, with an interface for allowing the user to decide on the item to attach to the model; and
a smart contract communication processing section for executing, by the computer, based on the user's decision on the item attachment to or detachment from the model, a transaction on the blockchain for associating or disassociating an item NFT for the attached or detached item with or from a model NFT for the smart contract for the model.

11. The system of claim 10, wherein
the model is an avatar.

12. The system of claim 10, further comprising the step of
updating the data for displaying the model after the item attachment or detachment based on the execution of the transaction for the smart contract for the model.

13. The system of claim 10, further comprising the step of
providing a user interface for displaying the model after the item attachment or detachment based on the data for displaying the model after dress-up.

14. The system of claim 10, wherein
the step of executing the transaction executes both or either one of: a transaction for changing an ownership addresses of the item NFT of the item to be attached to the model from the user's wallet address to a smart contract address of an item avatar NFT, and/or a transaction for changing an ownership address of the item NFT of the item to be detached from the model from a smart contract address of an item avatar NFT to the user's wallet address.

15. The system of claim 14, wherein
when there is an item to be detached from the model and an item to be attached to the model,
after executing the transaction for changing an ownership address of an item NFTs of the item to be detached from the model from a smart contract address of an item avatar NFT to the user's wallet address,
execution of the transaction for changing an ownership address of an item NFT of the item to be attached to the model from the user's wallet address to a smart contract address of an item avatar NFT is permitted.

16. The system of claim 14, wherein
the step of providing the user, by the computer, with an interface for allowing the user to decide on an item to attach to the model
displays a button or a link on the interface for allowing the user to execute the transaction for attaching or detaching an item for each smart contract for the item.

17. The system of claim 16, wherein
the button or the link for allowing the user to execute the transaction for attaching an item
is activated or displayed after the transaction for detaching an item is executed.

18. The system of claim 11, further comprising the step of
generating, by the computer, the data for displaying the model for use in a specific metaverse, and allowing its download.
